(19) United States
(12) Patent Application Publication
(10) Pub. No.: US 2009/0185583 A1
(43) Pub. Date: Jul. 23, 2009

(54) UV and Visible Laser Systems

(75) Inventors: Dmitri Vladislavovich Kuksenkov, Painted Post, NY (US); Venkatapuram Sriraman Sudarshanam, Colorado Springs, CO (US); Luis Alberto Zenteno, Painted Post, NY (US)

Correspondence Address: CORNING INCORPORATED, SP-TI-3-1, CORNING, NY, 14831, US

(73) Assignee: CORNING INCORPORATED

(21) Appl. No.: 12/227,881

(22) PCT Filed: May 31, 2007
(86) PCT No.: PCT/US2007/012775

§ 371 Date: Dec. 1, 2008

Related U.S. Application Data
(60) Provisional application No. 60/810,505, filed on Jun. 2, 2006.

(51) Int. Cl. H01S 3/30

(52) U.S. Cl. 372/5; 372/6

(57) ABSTRACT

A laser system comprising: a light source generating light, said light source comprising at least two laser sources of different wavelengths; and a frequency converter operatively coupled to said light source to accept the light provided by said light source and to convert it to higher optical frequency such that said frequency converter is producing light output at the final output wavelength situated in the 150-775 nm range.

This application claims the benefit of U.S. Provisional Application No. 60/810,505, filed Jun. 2, 2006, entitled “UV and Visible Laser Systems.”

### BACKGROUND OF THE INVENTION

1. Field of the Invention

The present invention relates generally to solid state lasers and more particularly to laser systems using fiber lasers and nonlinear wavelength conversion to produce output in the ultra violet (UV) and/or visible wavelength ranges.

2. Technical Background

Coherent light sources in the visible (400-775 nm) wavelength range and in the UV or deep UV (DUV) range (150-400 nm) find a number of important applications (such as in medicine, life sciences material processing, photolithography and metrology). Typically, a high output power is desired and different output wavelengths are required for different applications.

However, in contrast to the widely available light sources developed for the near-IR spectral ranges, the choice of the shorter wavelength light sources (e.g., visible or UV) is very limited. Excimer lasers are often utilized to produce UV radiation at 248 nm, 193 mm, and 157 nm. However, these lasers are expensive, costly to maintain, have relatively poor beam quality, and are not tunable.

Harmonic conversion in nonlinear crystals is typically used to convert the IR (infrared) wavelength output of the diode pumped solid state (DPSS) laser to UV and visible ranges. Unfortunately, only a few discrete wavelengths are available from DPSS lasers, and therefore, the output wavelengths that are produced by this method are also limited to harmonics (e.g., 2^{nd}, 3^{rd}, 4^{th}) of the fundamental or pump wavelengths. Such laser outputs are, for example, 532 nm, 355 nm, and 266 nm that are produced by harmonic conversion of 1064 nm Nd:YAG laser output.

Optical Parametric Oscillators (OPO) may be utilized with a DPSS laser to provide additional output wavelength tunability, provided that a nonlinear crystal with a suitable transparency range and phase matching conditions exists. This is not always possible. Furthermore, because the output wavelength from OPO is determined by phase matching conditions of the nonlinear crystal, the laser systems utilizing OPOs are generally more complex, and suffer from poor stability, as compared to the laser systems that utilize harmonic converters only.

An additional disadvantage of DPSS lasers is that the average power output is limited to relatively low (10-25 W) values by thermal issues (heat dissipation in the laser crystal). To achieve high peak optical power values required for efficient nonlinear frequency conversion, they are typically operated either in Q-switched (long, 30-50 ns pulses) regime where the pulse repetition frequencies are limited to several kHz, or in a mode-locked (5-10 ps pulses) regime where the spectral width of the output is significantly larger, and therefore coherence length of the laser output is shorter then that of a continuous wave or CW laser. Therefore, such DPSS lasers are not suitable for producing quasi-CW output, where optical pulses are sufficiently long to keep the high coherence, but at the same time repetition frequency is high enough so that for a particular detector the output light appears effectively CW.

Therefore, a need still exists to develop high power, efficient and stable quasi-CW laser sources in the 0.15-0.775 μm range.

### SUMMARY OF THE INVENTION

One aspect of the invention is a laser system comprising: (i) a light source generating light, said light source comprising at least two laser sources of different wavelengths; and (ii) a frequency converter operatively coupled to said light source to accept the light provided by said light source and to convert it to higher optical frequency such that said frequency converter is producing light output at the final output wavelength situated in the 150-775 nm range. Preferably the two laser sources are fiber lasers or seeded fiber amplifiers.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and together with the description serve to explain the principles and operations of the invention.

### BRIEF DESCRIPTION OF THE DRAWINGS

FIG. 1A illustrates the ranges of the output wavelengths that can be generated by harmonic conversion using only Yb-doped fiber laser source, only Er-doped fiber laser source, and both Yb- and Er-doped fiber laser sources.

FIG. 1 is a block diagram view of the laser system 10 according to one embodiment of the present invention;

FIG. 2 illustrates schematically second exemplary embodiment of the laser system 10 according to the present invention;

FIG. 3 illustrates schematically third exemplary embodiment of the laser system 10 according to the present invention.

### DETAILED DESCRIPTION OF THE PREFERRED EMBODIMENTS

A non-cavity or non-resonant method and apparatus for generating coherent light are taught herein. In accordance with some embodiments of the present invention, a pulsed light source comprising at least two light sources of different wavelengths is used in the inventive method and apparatus to provide light to the frequency converter that converts it to higher optical frequency such that the frequency converter produces light output at the final output wavelength situated in the 150-775 nm range. The at least two light sources can be either lasers or seeded optical amplifiers (laser amplifiers), or a combination thereof and they are refereed to as laser sources or lasers herein.

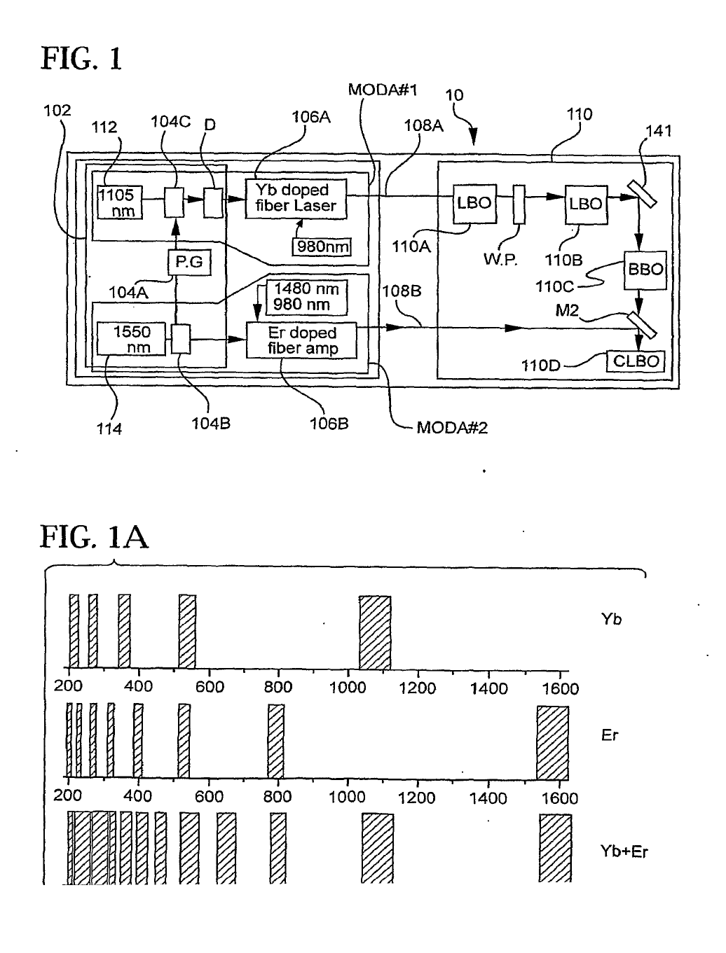

Reference will now be made in detail to the present preferred embodiments of the invention, examples of which are illustrated in the accompanying drawings. Whenever possible, the same reference numerals will be used throughout the drawings to refer to the same or like parts. One embodiment of the laser system of the present invention is shown in FIG. 1, and is designated generally throughout by the reference numeral 10.

Referring to FIG. 1, a laser system 10 of this embodiment includes a light source 102 that comprises two “master oscillator-power amplifiers” (MOPAs) that operate in parallel to simultaneously provide first pulsed light outputs 108A and 108B. While in principle, the laser system 10 may be a CW system, in this embodiment, it utilizes an optional electrical pulse generator 104A driving optical modulators 104B and 104C to provide pulse modulations of the master oscillators' (MOPAs') light.

In this embodiment, the light from the 1105 nm seed source 112 passes through the optical modulator 104B driven from the electrical pulse generator 104A. The modulated pulsed light enters the fiber amplifier 106A comprising an Yb-doped silica based fiber 106A′, and the amplifier 106A generates amplified pulsed light output signal 108A having an optical spectrum centered at an output wavelength λ_{1Aout}=1105 nm. The light from the 1550 nm seed source 114 passes through the optical modulator 104C and enters the amplifier 106B, for example an Er-doped fiber amplifier. The amplifier 106B provides amplified pulsed light output signal 108B having an optical spectrum centered at an output wavelength λ_{1Bout}=1550 nm. Thus, in this embodiment, since the optical modulators 104B and 104C are driven from the same electrical pulse generator 104A, the pulsed light source 102 of the laser system 10 provides synchronized light pulses 108A, 108B at two different wavelengths. The seed sources, as well as optional pulse generator (s), modulators and/or optical delay element(s) D comprise the initial (pulse) source 102′. That provide (two different wavelength) light to high power lasers or/and amplifiers 106A, 106B.

The frequency converter 110 is operatively coupled to the light source 102 (which in this embodiment is a pulsed light source) to accept the first pulsed light output 108A, 108B at the respective wavelengths λ_{1Aout}, λ_{1Bout}, and to convert it to higher optical frequency, such that the frequency converter 110 is producing the final pulsed light output 112 at the wavelength λₒᵤₜ situated in the 150-775 nm range. The frequency converter 110 may include second harmonic generation (SHG) and sum frequency mixing (SFM) stages. The simplest type of a frequency converter is a harmonic generator producing, for example, 2^{nd}, 3^{rd}, or 4^{th} harmonic, etc., which means that it is converting the first output wavelength λ_{1Aout} to the final wavelength of λₒᵤₜ=λ_{1Aout}/2; λ_{1Aout}/3, or λ_{1Aout}/4. In general for arbitrary combination of an arbitrary number of SHG and SFM stages, 1/λₒᵤₜ=m/λ_{1Aout}+n/λ_{1Bout}, where m and n are integer numbers.

According to some of the embodiments, the pulse width provided by the light source 102 is 0.01 to 100 ns and a duty cycle of the pulses is 1:2 to 1:1000000, for example 0.1 ns to 10 ns with duty pulse cycle of 1:3 to 1:1000. For optimum efficiency, it is important to consider the requirements for the optical pulse width and repetition frequency. In principle, there is no upper limit on the optical pulse width. However, for pulses longer than a few nanoseconds, stimulated Brillouin scattering (SBS) in the amplifier (or laser) fiber can limit the maximum amount of power that can be converted and one has to make sure that the pump optical spectrum is broad enough to suppress SBS. Also, to increase the nonlinear conversion efficiency in crystals, it is desirable that the duty cycle (the ratio of pulse width and repetition period, which is also the ratio of average to peak power) is less than 1:100, which, for pulses longer than 10 ns, will limit the repetition frequency to values lower than 1 MHz, which is not desirable if the goal is to produce a quasi-CW source.

The high-power optical amplifiers 106A, 106B amplify the pulsed light 104 from the seeds 112 and 114, such that the average power and the peak pulse power of the pulsed light source 102 can be increased. In this way, cost-effective pump sources based on the well developed fiber amplifier technology for the amplifiers 106A, 106B may be utilized. The method and apparatus of the present invention are especially suitable for use with Yb-doped or Er-doped fiber optical amplifiers, but can also be used with other types of power amplifiers 106A, 106B. More specifically, it is noted that an Yb-doped fiber based laser can provide an optical output in the 1030 to 1120 nm range and Er, Tm and Nd-doped silica fiber based lasers or amplifiers are capable of providing an output in 1530-1610 nm, 1800-2000 nm, and 890-930 nm ranges, respectively. Adjustment in the output wavelength of these diode pumped fiber lasers will allow one to adjust/tune the final output wavelength to its desired value. In addition, due to long (meters) length of the active medium, fiber lasers do not suffer from heat dissipation issues as much as DPSS lasers and are therefore capable of providing much higher average power output, keeping a perfect single transverse mode beam quality. Thus, fiber lasers are perfect candidates for creating high power CW, quasi-CW or nanosecond pulse sources in visible and UV ranges by harmonic conversion.

FIG. 1A illustrates the wavelength ranges that can be generated from an Yb-doped fiber laser source and its harmonics (top), Er-doped fiber laser source and its harmonics (middle), and these two fiber lasers sources together (bottom), including the shorter wavelengths produced by SHG and SFM. FIG. 1A illustrates that using both of these two laser sources one can achieve an output at a wider variety of wavelengths, including those ranging from less then 200 nm to 400 nm, and several ranges of longer wavelengths. The advantage is evident in FIG. 1A in that the bottom plot contains wavelength bands not present in either of the two top plots (which means that those can be generated only when using both Yb- and Er-doped fiber lasers). Different combination of laser sources (e.g., Er and Nd; Yb and Tm; Er and Tm) would, of course, allow one to produce the output in different wavelength ranges, some of which may overlap with those depicted in FIG. 1A.

According to some embodiments of the present invention the light source 102 includes a tunable laser for tuning the source wavelength λₚ, wherein the tuning of the source wavelength (and harmonic conversion stages, if required) provides fine tuning of the final output wavelength λₒᵤₜ.

Due to a very long (several ms) lifetime of the excited states, rare-earth (e.g., Er or Yb) doped fiber amplifiers essentially amplify the average power of the incoming signal, and for a very small duty cycle, an amplifier 106A, 106B with only a modest average power output can produce very large peak pulse power. For example, 1 ns long pulses from master oscillators (seed 112 and pulse modulator 104C; seed 114 and pulse modulator 104B such as, for example, externally modulated distributed feedback (DFB) laser diodes) can be amplified to a peak power of 20 kW in a multiple-stage Er and Yb-doped (fiber) amplifiers 106A, 106B, while the average output power of power amplifiers 106A, 106B is only 2 W, if the repetition rate is 100 KHz (peak power is 10000× average power).

Directly modulating a semiconductor laser diode with an electrical pulse generator or connecting the diode output, as described above, to a separate electro-optic intensity modulator for setting the pulse width, can be used to make the initial pulsed light source 102′ for generating the pulsed light 104, with or without further amplification (i.e. with or without the amplifiers 106A, 106B). As noted above, forming, a rectangular pulse is preferred for maximizing the frequency conversion efficiency (minimizing the effect of incomplete conversion in the pulse wings) and minimizing spectral broadening in high-power fiber amplifiers (by self-phase modulation (SPM)). Since Er, Yb, Tm and Nm-doped amplifiers 106A, 106B have a relatively wide spectral gain bandwidth (several 10s of nanometers), the pulsed light source 102 and to some extent the whole laser system 10 can be made wavelength tunable or adjustable by using a tunable master oscillator pulse source 102′ (such as an external cavity semiconductor laser, directly modulated or coupled to a separate modulator).

As already mentioned above, output wavelength range of approximately 1030-1120 nm is directly accessible for an Yb-doped fiber laser systems. Other types of fiber laser systems, such as those including a silica based fiber which is Er—Yb co-doped for 1530-1570 nm range, Nd-doped for 890-930 nm range (working at the 3-level transition) or Tm-doped for 1800-2000 nm range, can also be utilized. Frequency converter 110 can include a number of stages, each one generating a second, third or fourth harmonic or performing a sum frequency mixing of the fiber lasers and preceding stages outputs, to provide the desirable output wavelength at the end. Output wavelengths λₒᵤₜ can be produced by sum frequency mixing, in a suitable nonlinear crystal, the outputs of two different fiber lasers or amplifiers. Since the two lasers/seeded amplifiers 106A, 106B provide different output wavelengths and are tunable or adjustable within a range of wavelengths, using the two of such lasers/amplifiers in conjunction with one another greatly enhances our ability to tune or adjust the final output wavelength λout. Therefore, in accordance with the teachings of the present invention, any desired output wavelength λₒᵤₜ in the 150-775 nm range can be produced by a suitable combination of two pulsed fiber lasers or seeded amplifiers 106A, 106B, and the frequency converter 110 that includes harmonic generation stage(s) and/or sum-frequency mixing stage(s), as will be illustrated, for example, below.

In the following, we present examples of laser systems 10 producing some specific output wavelengths, of interest for specific applications. In the following exemplary embodiments, we choose to design frequency converters 110 in that utilize exclusively borate nonlinear crystals (LBO, BBO, CLBO), which are known to have the highest optical damage thresholds and are therefore capable of producing higher powers by harmonic conversion. Advantageously, these laser systems 10 achieve relatively high conversion efficiency, while avoiding or minimizing potential crystal damage caused by incident high power beams at short wavelengths (UV). This is done, at least partially, by “trading” short wavelength (UV) power for long wavelength (IR) power when doing sum frequency generation (SFG) to produce UV output wavelength (since the output power of the SFG stage is proportional to the product of the two input powers, more of the IR light and less of the UV can be supplied to the input of the stage to produce the same output). Those skilled in the art will appreciate that these examples represent only a small subset of the many possibilities and that other non-linear crystals may also be utilized.

### Example 1

### Laser system I for Producing an Output at λ=193.0 nm

Sub-200 nm laser light sources are very important for metrology applications in the semi-conductor industry. As the feature sizes of integrated circuits are shrinking, shorter wave-length light is used for a photolithography. Mask and wafer inspection, as well as optics manufacturing is then in need of the same or similar DUV light wavelength. The systems presently used, based on solid-state laser sources, harmonic conversion and OPOs, typically work at very low repetition rates, are very bulky, complex, expensive and require frequent and complicated maintenance.

FIG. 1 illustrates schematically the first exemplary embodiment of the 193.0 nm laser system 10. As described above, the optical system 10, according to this embodiment, includes two optical fiber amplifiers 106A, 106B that provide synchronized pulse outputs of different wavelengths to the frequency converter 110. In this exemplary embodiment, the Yb-doped fiber amplifier 106A of the light source 102, produces a narrow linewidth output centered at the wavelength λ_{1Aout}=1104 nm. The first output signal 108A from the amplifier 106A is then provided to the first stage of the frequency converter 110. In this embodiment, the frequency converter 110 includes two LBO (Lithium triborate, LiB₃O₅) crystals 110A, 110B, a BBO (beta barium borate, β-BaB₂O₄) crystal 110C, and a CLBO (cesium lithium borate, CsLiB₆O₁₀) crystal 110D. The three nonlinear crystals, LBO 110A, LBO 110B and BBO 110C, are used to generate the 5^{th} harmonic of the 1104 nm wavelength by: (i) second harmonic generation (SHG) via LBO 110A producing wavelength of 552 nm, (ii) a third harmonic generation via sum-frequency mixing (SFM) of residual 1104 nm light and 552 nm light within the LBO 110B, producing the 368 nm wavelength, (iii) sum-frequency mixing (SFM) of 368 nm and 552 nm light via BBO 110C producing 220.8 nm output. The LBO crystal 110B receives the light at 552 nm and converts part of it (1 to 90%, preferably 50%) to 368 nm light. In this embodiment, a custom waveplate WP is needed between the two LBO crystals 110A and 110B to rotate one of the polarization states (of 1104 nm light or 552 nm light) but not the other, so that they are aligned along the same direction at the second LBO crystal 110B. Any residual light at 1104 nm wavelength is filtered out of the system by filter (dichroic mirror) M1. This 368 nm light, exiting the LBO crystal 110B together with the residual 552 nm light (99% to 10%), is then provided to the BBO crystal 110C which generates, via sum frequency mixing (SFM), light at the wavelength of 220.8 nm. The Er-doped fiber amplifier 106B of the light source 102, produces a narrow linewidth output centered at the wavelength λ_{1Bout}=1535 nm. The first output signal 108B from the amplifier 106B is then provided to the stage 110D of frequency converter 110 which, in this embodiment, is the CLBO crystal. Any residual light at 552 nm or 368 nm wavelengths is filtered out of the system by filter (dichroic mirror) M2. The first output signal 108B at the (IR) wavelength of 1535 nm is then sum frequency mixed within the fourth stage 110D (CLBO crystal) with the 220.8 nm light provided by the BBO crystal 110C, so that the fourth stage 110D (CLBO crystal) produces the output at the wavelength of λₒᵤₜ=193.0 nm. The output power Pₒᵤₜ of the output wavelength λₒᵤₜ=193.0 nm is proportional to the product of the two input powers Pₒᵤₜ˜P_{1535 nm}×P_{220.8 nm}, where P_{1535 nm} is the optical power provided to the CLBO crystal from the amplifier 106B (IR wavelength, 1535 nm) and P_{220.8 nm} is the optical power provided to the CLBO crystal from the BBO crystal 110C (UV wavelength, 220.8 nm). Because the damage to the nonlinear crystals is primarily caused by the high power beams in short wavelengths range, we can provide less optical power from the BBO crystal 110C, and more power from longer wavelength source (the amplifier 106B, P_{1535 nm}), thereby “trading” short wavelength (UV) incident power for long wavelength (IR) incident power, and thus avoiding or minimizing potential crystal damage caused by incident high power beam at short wavelength (UV). Accordingly, it is preferable that laser that provides longer wavelength light to the last stage of the frequency converter 110 (or to any SFM stage), such as Er-doped fiber amplifier 106B, provide the output optical power of at least 10 W, and preferably at least 50 W.

The optimum temperature for the first LBO crystal 110A (as predicted by SNLO, a free nonlinear crystal modeling software package from Sandia National Laboratories) is 376.4 Kelvin. At this temperature, the crystal operates in non-critical phase matching (for light propagating at the angles of θ=90° and φ=0° to the optic axes of the crystal—LBO is a so-called bi-axial crystal) with the effective nonlinearity coefficient of d_{eff}=0.85 pm/V and essentially zero birefringent walk-off for the second harmonic generation of 552 nm. The second LBO crystal 110B can not be non-critically phase matched. For the light propagating at θ=90° and φ=32.6° to the optic axes, the phase matching temperature for the sum frequency mixing of 1104 and 552 nm is 433 K, the effective nonlinearity is d_{eff}=0.75 pm/V and the birefringent walk-off is 15.99 milliradians. The BBO crystal 110C is a uni-axial crystal. For light propagating at θ=64.2° to its optic axis, the phase-matching crystal temperature is 433 K, the effective nonlinearity is d_{eff}=1.3 pm/V and the birefringent walk-off is 71 milliradians, for the nonlinear process of sum frequency mixing of 552 nm and 368 nm light. The fourth crystal, CLBO is a uni-axial crystal. For light propagating at θ=62.3° to its optic axis, the phase-matching crystal temperature is 433 K, the effective nonlinearity is d_{eff}=1.01 pm/V and the birefringent walk-off is 37.33 milliradians. As shown in FIG. 1, no OPOs were utilized in his embodiment of the laser system 10. Table I provides the summary of crystal's parameters utilized in the laser system 10 of example 1.

In Table I, as well as in all subsequent examples, the first row lists the type of the nonlinear crystal(s) used and the second the type of a nonlinear process the crystal is performing. Rows 3-5 list the output and two input wavelengths (for the case when the nonlinear process is a second harmonic generation, the two input wavelengths are the same). Row 6 provides the crystal temperature and rows 7-8 provide the propagation direction angles with respect to the crystal optic axes required for phase matching. Row 9 specifies the effective nonlinearity coefficient (a measure of how efficient the conversion can be for a given input power and crystal length), and row 10 provides the value for input and output beam angular walk-off (slight angular separation of the input light and the harmonic light within the crystal) caused by crystal birefringence.

TABLE I
Calculated phase matching parameters for
crystals in laser system 10 of FIG. 1

| Crystal | LBO | LBO | BBO | CLBO |
|---|---|---|---|---|
| Nonlinear process | SHG | SFM | SFM | SFM |
| First input λ, nm | 1104 | 1104 | 552 | 1535 |
| Second input λ, nm | | 552 | 368 | 220.8 |
| Output λ, nm | 552 | 368 | 220.8 | 193.0 |
| Phase matching temperature, K | 376.4 | 433 | 433 | 433 |
| Phase matching angle | 90 | 90 | 64.2 | 62.3 |
| θ, degrees | | | | |
| Phase matching angle | 0 | 32.6 | N/A | N/A |
| φ, degrees | | | | |
| Effective nonlineaity | 0.85 | 0.75 | 1.3 | 1.01 |
| d_{eff}, pm/V | | | | |
| Birefringent walkoff, mrad | ~0 | 15.99 | 71.62 | 37.33 |

The non-critical phase matching (NCPM) at θ=90° (and φ=0°, for bi-axial crystals) is the most preferable kind since it allows maximum angular and spectral acceptance (deviation of propagation direction and wavelength allowable without significant degradation of the conversion efficiency) for second harmonic generation and is characterized by zero or nearly zero birefringent walk-off of the pump and second harmonic light beams, which allows using long crystals to achieve high conversion efficiency with moderate levels of peak power.

The advantage of the example laser system 10 of FIG. 1 is that it provides the sub-200 nm output, starting with Er- and Yb-doped fiber lasers for which a well developed manufacturing technology is available. However, it exhibits a significant birefringent walk-off (71.6 mrads) in the BBO crystal 110C. Large walk-off does not allow tight focusing of the laser beams and therefore results in the lower conversion efficiency, since a shorter crystal or larger beams (lower optical power density) have to be used. The walk-off influence can be reduced if multiple 180° rotated crystals of the same kind are used, but this is likely to reduce the useful lifetime of the device, because more surfaces will be exposed to the high optical power. Diffusion or adhesive-free bonding can be utilized to eliminate additional exposed crystal surfaces by seamlessly joining the 180° rotated crystals together. Another possible solution is to focus the incoming light beam(s) into an elliptical spot within the nonlinear crystal, with the longer axis of the ellipse oriented along and the shorter axis perpendicular to the walk-off direction. In this case, the higher conversion efficiency can be achieved (due to the tighter focusing in the no walk-off direction and therefore higher power density and the possibility to use a longer crystal) while at the same time minimizing a beam distortion caused by the walk-off.

### Example 2

### Laser System for Producing an Output at λ=193.4

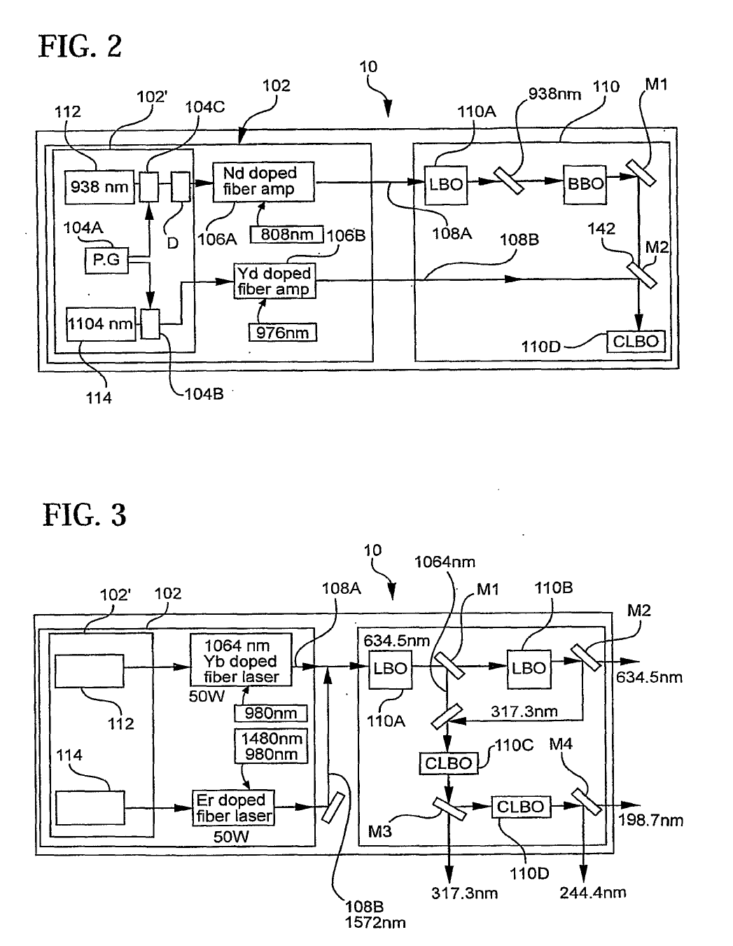

FIG. 2 presents an example of a 193.0 nm laser system 10 according to another embodiment of the present invention. The laser system 10 of this embodiment is similar to that of the embodiment of example 1 in that it includes a pulsed light source 102 comprising two seeded high power optical amplifiers 106A, 106B that (in parallel) provide synchronized first pulsed light 108A, 108B to the frequency converter 110. However, in this embodiment the first amplifier 106A is Nd-doped (SiO₂ based) fiber amplifier. More specifically, the 935.6 nm output of Nd-doped amplifier 106A is provided to the first stage 110A. (LBO crystal) of the frequency converter 110. The 1104 nm output of Yb-doped fiber amplifier 106B is simultaneously provided to the CLBO crystal (3^{rd} stage 110C of the frequency converter 110). The frequency converter 110 includes one LBO crystal 110A, one BBO crystal 110B and one CLBO crystal 110C. The three nonlinear crystals, LBO 110A, BBO 110B and CLBO 110C, are used to generate 193.0 nm wavelength by: (i) second harmonic generation (SHG) via LBO 110A producing wavelength of 467.8 nm, (ii) another SHG (BBO 110B producing the 233.9 nm wavelength), (iii) and sum-frequency mixing (SFM) of 233.9 nm provided by the BBO crystal 110B and the 1104 nm light provided by the Yb-doped amplifier 106B, via CLBO 110C, producing 193.0 nm output. More specifically, LBO and BBO crystals 110A and 110B are second harmonic generators (SHGs). The LBO crystal 110A receives the first output wavelength λ₁ₒᵤₜ of 935.6 nm from the Nd-doped fiber amplifier 106A and provides 467.8 nm output to the second BBO crystal 110B. Any residual light at 935.6 nm wavelength is optionally filtered out of the system by filter such as a dichroic mirror (not shown). The BBO crystal 110B receives the light at 467.8 nm and converts part of it to the 233.9 nm light. The remaining 467.8 nm light is then optionally filtered out by the dichroic mirror M1. The 233.9 nm light, exiting the BBO crystal 110B, together with the 1104 nm light from the Yb doped fiber amplifier 106B, is then provided to the CLBO crystal 110C which generates, via sum frequency mixing (SFM), light at the desired wavelength λₒᵤₜ=193.0 nm. The operating temperature for the first LBO crystal 110A is 433 Kelvin. The phase matching angles θ and φ are 90° and 16.4°, respectively. The crystal operates with the effective nonlinearity coefficient of d_{eff}=0.83 pm/V and only 9.28 mrad of birefringent walk-off for the second harmonic generation of 935.6 nm. For the second crystal, BBO 110B, for the light propagating at φ=59.0° to the optical axis, the phase matching temperature for the second harmonic generation of 233.9 nm is also 433 K, the effective nonlinearity is d_{eff}=1.45 pm/V and the birefringent walk-off is 78.3 milliradians. The third crystal, CLBO 110C, operates in non-critical phase matching (for light propagating at the angle of θ=90° to the optical axis of the crystal) with the effective nonlinearity coefficient of d_{eff}=1.12 pm/V and essentially zero birefringent walk-off. Optimum operating temperature for this crystal is 384 K for the nonlinear process of sum frequency mixing of 233.9 and 1104 nm. The output power Pₒᵤₜ of the output wavelength λₒᵤₜ=193.0 nm is proportional to the product of the two input powers Pₒᵤₜ˜P_{1104 nm}×P_{233.9 nm}, where P_{1104 nm} is the optical power provided to the CLBO crystal from the amplifier 106B (IR wavelength, 1104 nm) and P_{233.9} nm is the optical power provided to the CLBO crystal from the second stage BBO crystal 110B (LTV wavelength, 233.9 nm). Because the damage to the nonlinear crystals is primarily caused by the high power beams in short wavelengths range, we can provide less optical power from the BBO crystal 110C, and more power from longer wavelength source (the amplifier 1068, P_{1150 nm}), thereby “trading” short wavelength (UV) incident power (on the crystal) for long wavelength (IR) incident power, and thus avoiding or minimizing potential crystal damage caused by incident high power beams in short wavelengths (UV). Accordingly, it is preferable that laser that provides longer wavelength light to the last stage of the frequency converter 110 (or to any SFM stage), such as Yb-doped fiber amplifier 106B, provide the output optical power of at least 10 W, and preferably at least 50 W.

Table II provides the summary of crystal's parameters utilized in the laser system 10 of example 2.

TABLE II

| Crystal | LBO | BBO | CLBO |
|---|---|---|---|
| Nonlinear process | SHG | SHG | SFM |
| First input λ, nm | 935.6 | 467.8 | 1104 |
| Second input λ, nm | | | 233.9 |
| Output λ, nm | 467.8 | 233.9 | 193.0 |
| Phase matching temperature, K | 433 | 433 | 384 |
| Phase matching angle θ, degrees | 90 | 59.0 | 90 |
| Phase matching angle φ, degrees | 16.4 | N/A | N/A |
| Effective nonlineaity d_{eff}, pm/V | 0.83 | 1.45 | 1.12 |
| Birefringent walkoff, mrad | 9.28 | 78.3 | ~0 |

For simplicity, additional optical elements are not shown in optical schematics given for the examples. Those skilled in the art will be able to determine where and when such elements should be used. These optional elements are, for example, lenses for focusing light beams on the nonlinear crystals, to increase conversion efficiency, waveplates used to rotate the polarization of light, additional dichroic mirrors, beam splitters etc.

The advantage of the laser system 10 of FIG. 2 is that a minimum number of nonlinear crystals (only 3) are used to produce the sub-200 nm output. However, it exhibits a significant birefringent walk-off (78 mrad) in the BBO crystal 110B. Large walk-off does not allow tight focusing of the laser beams and therefore results in the lower conversion efficiency, since a shorter crystal or larger beams (lower optical power density) have to be used. The walk-off influence can be reduced if multiple 180° rotated crystals of the same kind are used, but is likely to reduce the useful lifetime of the device, because more surfaces will be exposed to the high optical power. Diffusion or adhesive-free bonding can be utilized to eliminate additional exposed crystal surfaces by seamlessly joining the 180° rotated crystals together. Another possible solution is to focus the incoming light beam(s) into an elliptical spot within the nonlinear crystal, with the longer axis of the ellipse oriented along and the shorter axis perpendicular to the walk-off direction. In this case, the higher conversion efficiency can be achieved (due to the tighter focusing in the no walk-off direction and therefore higher power density and the possibility to use a longer crystal) while at the same time minimizing a beam distortion caused by the walk-off.

Those skilled in the art will appreciate that in this and other examples, even with the exact same set of wavelengths, different nonlinear crystals can be used to perform the required conversion.

The last crystal (CLBO) is close to the non-critical phase matching condition and therefore, birefringent walk-off is nearly negligible. In addition, a high peak IR (1104 um) power is supplied to it directly from Yb-doped MOPA. This can result in conversion efficiency in respect to UV power approaching 80%, and therefore minimum incoming UV power into the CLBO crystal will be needed to achieve the same DUV (deep UV) power output, thus minimizing optical damage to the CLBO crystal. It is noted that the optical power values as well as temperatures, phase matching angles, effective nonlinearity coefficient and birefringent walk-off values shown in Table II (and other Tables provided herein) are given only as a guideline. Other configurations and operating temperatures may also be utilized.

### Example 3

### Laser System for Producing an Output at λ=198.7 nm

FIG. 3 illustrates schematically the exemplary embodiment of the 198.7 nm laser system 10. As described above, the optical system 10 according to this embodiment, includes two seeded optical fiber amplifiers 106A, 106B that provide synchronized pulsed outputs of different wavelengths to the frequency converter 110. In this exemplary embodiment, the 1064 nm seeded Yb-doped fiber amplifier 106A of the light source 102, produces a narrow linewidth output at the wavelength λ_{1Aout}=1064 nm. Seeded Er-doped fiber amplifier 106B simultaneously produces light 108B at a narrow linewidth output at wavelength λ_{2Aout}=1572 nm. The 1164 nm and 1572 nm light from the amplifiers 106A, 106B is then provided to the first stage of the frequency converter 110. In this embodiment, the frequency converter 110 includes two LBO crystals 111A, 110B, and two CLBO crystals 110C, 110D. The first stage of the frequency converter 110 corresponds to the LBO crystal 110A. The 1164 nm and 1572 nm light beams are sum frequency mixed (SFM) in the LBO crystal 110A to produce the 634.5 nm light. The 634.5 nm light then passes through the dichroic mirror M1, which filters out the residual 1064 um light. The residual (10% to 90%, preferably 40% in this embodiment) 1064 nm light is then directed towards the third nonlinear crystal, CLBO 110C. The second LBO crystal 110B converts (via second harmonic generation, SHG) the 634.5 nm to the 317.3 nm light which is reflected by the dichroic mirror M2 and toward the CLBO crystal 110C. The 1064 nm and 317.3 nm light beams are sum frequency mixed (SFM) in the CLBO crystal 110C to produce the 244.4 nm light. The dichroic mirror M3 filters out the residual 317 nm light, but passes through the 244.4 nm light and the residual 1064 nm light (10% to 90% of light incident on the CLBO crystal 110C, preferably 50% in this embodiment) remaining unused after passing through the nonlinear crystals 110A and 110C. The 1064 nm and 244.4 nm light beams are sum frequency mixed (SFM) in the CLBO crystal 110D to produce the output 198.7 nm light.

The output power Pₒᵤₜ of the output wavelength λₒᵤₜ=198.7 nm is proportional to the product of the two input powers Pₒᵤₜ˜P_{1064 nm}×P_{244.4 nm}, where P_{1064 nm} is the optical power (e.g. 20 W) of 1064 nm (IR wavelength) provided to the CLBO crystal 110D and P_{244.4 nm} is the 244.4 nm (UV wavelength) optical power provided to the CLBO crystal 110D from the third stage CLBO crystal 110C. Because the damage to the nonlinear crystals is primarily caused by the high power beams in short wavelengths range (UV), we can provide less optical power in the UV range from the CLBO crystal 110C, and more optical power from longer wavelength source (P_{1064 nm}), thereby “trading” short wavelength (UV) incident power for long wavelength (IR) incident power, and thus avoiding or minimizing potential crystal damage. Similar “trade” was performed to prevent damage to the CLBO crystal 110C by the 317.3 nm light. Accordingly, it is preferable that laser that provides longer wavelength light to the last stage of the frequency converter 110 (but it can be provided to any SFM stage), such as, in this embodiment, both the Yb-doped fiber amplifier 106A and the Er-doped fiber amplifier 106B, provide the output optical power of at least 10 W, and preferably at least 50 W to the frequency converter 110.

The optimum temperature for the first LBO crystal 110A is 287.5 Kelvin. At this temperature, the crystal operates in non-critical phase matching (for light propagating at the angles of θ=90° and φ=0° to the optic axes of the crystal) with the effective nonlinearity coefficient of d_{eff}=0.83 pm/V and essentially zero birefringent walk-off for the sum frequency mixing of 1064 and 1572 nm. The second LBO crystal 110B can not be non-critically phase matched. For the light propagating at θ=90° and φ=54.5° to the optic axes, the phase matching temperature for the second harmonic generation of 634.5 nm is 433 K, the effective nonlinearity is d_{eff}=0.53 pm/V and the birefringent walk-off is 17.05 milliradians. The CLBO crystals 110C and 110D are uni-axial. For the third non linear crystal, CLBO 110C light is propagating at θ=560 to its optic axis, the phase-matching crystal temperature is 433 K, the effective nonlinearity is d_{eff}=0.78 pm/V and the birefringent walk-off is 37.25 milliradians, for the nonlinear process of sum frequency mixing of 1064 nm and 317.26 nm light. For the fourth crystal, CLBO 110D, for light propagating at θ=81.3° to its optic axis, the phase-matching crystal temperature is 433 K, the effective nonlinearity is d_{eff}=1.07 pm/V and the birefringent walk-off is 12.99 milliradians, for the nonlinear process of sum frequency mixing of 1064 nm and 244.4 nm light. As shown in FIG. 3, no OPOs were utilized in this embodiment of the laser system 10. Table III provides the summary of crystal's parameters utilized in the laser system 10 of example 3.

Table III provides the summary of crystal's parameters utilized in the laser system 10 of example 3.

TABLE III

| Crystal | LBO | LBO | CLBO | CLBO |
|---|---|---|---|---|
| Nonlinear process | SFM | SHG | SFM | SFM |
| First input λ, nm | 1064 | 634.53 | 1064 | 1064 |
| Second input λ, nm | 1572 | | 317.26 | 244.39 |
| Output λ, nm | 634.53 | 317.26 | 244.39 | 198.74 |
| Phase matching temperature, K | 287.5 | 433 | 433 | 433 |
| Phase matching angle | 90 | 90 | 56 | 81.3 |
| θ, degrees | | | | |
| Phase matching angle | 0 | 54.5 | N/A | N/A |
| φ, degrees | | | | |
| Effective nonlineaity | 0.83 | 0.53 | 0.78 | 1.07 |
| d_{eff} pm/V | | | | |
| Birefringent walkoff, mrad | ~0 | 17.05 | 37.25 | 12.99 |

It is noted that in the above examples the embodiments of laser system 10 do not utilize OPOs, thus producing stable outputs at the desired output wavelength. The output wavelength λₒᵤₜ is uniquely determined by the wavelengths of lasers(s)/amplifier(s) 106A, 106B of the light source 102 and is not dependent on phase matching to keep it stable.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

What is claimed is:

1. A laser system comprising:
a light source generating light, said light source comprising at least two laser sources of different wavelengths; and
a frequency converter operatively coupled to said light source to accept the light provided by said light source and to convert it to higher optical frequency such that said frequency converter is producing light output at the final output wavelength situated in the 150-775 nm range.

2. The laser system of claim 1, wherein said laser system does not include an Optical Parametric Oscillator (OPO).

3. A laser system comprising:
a light source generating a light, said light source comprising at least two fiber laser sources of different wavelengths, each providing more than 10 W of optical power; and
a frequency converter operatively coupled to said light source to accept the light provided by said light source and to convert it to higher optical frequency such that said frequency converter is producing light output at the final output wavelength situated in the 150-775 nm range.

4. The laser system of claim 2 wherein each of said at least two fiber laser provides more than 50 W of optical power.

5. The laser system of claim 2 wherein at least one of said two fiber laser sources is tunable.

6. The laser system of claim 2, wherein said light source is a pulsed light source and the light provided to said frequency converter is pulsed light.

7. The laser system of claim 7, wherein the pulsed light source has a pulse width of 0.01 to 100 ns and a duty cycle of 1:2 to 1:1000000.

8. The laser system of claim 7, wherein pulsed light source is a master oscillator power amplifier MOPA.

9. The laser system of claim 1, wherein one of at least one of said two laser sources is a Yb doped fiber laser or fiber amplifier.

10. The laser system of claim 10, wherein the other one of said two laser sources is Nd doped fiber laser or fiber amplifier.

11. The laser system of claim 10, wherein the other one of said two fiber lasers is Er doped fiber laser.

12. The laser system of claim 1, wherein said at least two laser sources are arranged in a parallel configuration so as to provide the frequency converter with two output wavelengths.

13. The laser system of claim 1, wherein said at least two laser sources are arranged in a parallel configuration so as to provide the frequency converter with two synchronous output wavelengths.

14. The laser system of claim 1, wherein the pulsed light source comprises a tunable laser for tuning the source wavelength, wherein the tuning of the source wavelength provides fine tuning of the final output wavelength.

15. The laser system of claim 1, wherein said frequency converter includes no more than 4 conversion crystals.

16. The laser system of claim 8, further comprising a high-power optical fiber amplifier for amplifying the pulsed light to increase and set the peak pulse power, wherein the high-power optical amplifier comprises an optical fiber doped with at least one rare-earth dopant member selected from a group consisting of Ytterbium, Erbium, and Thulium.
